(19) United States
(12) Patent Application Publication
(10) Pub. No.: US 2024/0159720 A1
(43) Pub. Date: May 16, 2024

(54) CHROMATOGRAPHY SYSTEM AND METHOD

(71) Applicant: Agilent Technologies, Inc., Santa Clara, CA (US)

(72) Inventors: Stefan Mittrich, Kapsweyer (DE); Sascha Lege, Baden-Wuerttemberg (DE)

(21) Appl. No.: 18/388,487

(22) Filed: Nov. 9, 2023

(30) Foreign Application Priority Data
Nov. 11, 2022 (GB) 2216832.2

(51) Int. Cl. G01N 30/86; G01N 30/34

(52) U.S. Cl. CPC G01N 30/8693; G01N 30/34; G01N 30/8641; G01N 30/8662; G01N 30/8637

(57) ABSTRACT

A chromatography system includes a chromatogram modeling device for synthesizing a modeled reference chromatogram, and an evaluation device for evaluating operation conditions of a chromatography device based on the modeled reference chromatogram.

### CROSS-REFERENCE TO RELATED APPLICATIONS

The present application claims the benefit of British patent application No. 2216832.2, filed on Nov. 11, 2022, which is hereby incorporated by reference in its entirety.

### FIELD OF THE DISCLOSURE

The present disclosure relates to a chromatography system, preferably for chromatographic sample separation, with an evaluation device and/or a chromatogram modeling device. The present disclosure further relates to a corresponding method and a corresponding use.

### BACKGROUND ART

Chromatographic devices (often referred to also as instruments) are provided for analysing a sample, such as for carrying out a chromatographic separation of the sample.

For example, in liquid chromatography, a fluidic analyte may be pumped through a column comprising a material which is capable of separating different components of the fluidic analyte. Such a material, so-called beads, may be filled into a column tube which may be connected to other elements (like a control unit, containers including sample and/or buffers). Upstream of a column, the fluidic analyte is loaded into the liquid chromatography apparatus. A controller controls an amount of fluid to be pumped through the liquid chromatography apparatus, including controlling a composition and time-dependency of a solvent interacting with the fluidic analyte. Such a solvent may be a mixture of different constituents.

When setting up such a chromatography device, for example for a specific analysis application, several adjustments, in particular calibrations, have to be performed to establish the desired operation conditions (in other words: the configuration). Generally, a system/instrument test is performed to check, if the chromatography device is performing as expected. Generally, a measurement (of a standard sample) is performed with a defined configuration (e.g. regarding sample, column, method, etc.) and the measured chromatogram is then compared with an expected chromatogram, e.g. a measured chromatogram of a qualified chromatography device (qualified for said configuration) at the manufacturer side. The comparison may include an evaluation of characteristics such as absolute or relative retention time, peak width, resolution, tailing, signal-to-noise ratio, etc.

However, the measured chromatogram is dependent on the instrument configuration and there are many options of setting up such a configuration, for example based on the modularity of modern chromatography devices. Actually, the number of theoretically possible combinations makes it nearly impossible to provide a measured chromatogram (from a qualified chromatography device) for each possible configuration. Hence, for a plurality of uncommon configurations, there may be simply no measured reference (standard) chromatogram available.

### SUMMARY OF THE DISCLOSURE

There may be a need to evaluate the operation conditions, in particular uncommon operation conditions, of a chromatography device in an efficient and reliable manner.

According to a first aspect, an evaluation device is provided for evaluating operation conditions of a chromatography device based on a modeled reference chromatogram, in particular from a modeling device as described below.

According to a second aspect, a chromatogram modeling device is provided for synthesizing a modeled reference chromatogram for specific operation conditions of a chromatography device, in particular for evaluation of the operation conditions by an evaluation device as described above.

The evaluation device and the chromatogram modeling device may be understood as being interrelated products, i.e. different objects that complement each other or work together, for example such as a transmitter and a receiver.

According to a third aspect, a chromatography system is provided, comprising: an evaluation device as described above, and a chromatogram modeling device as described above.

According to a fourth aspect, a method is provided, the method comprising: i) synthesizing a modeled reference chromatogram, and ii) evaluating operation conditions of a chromatography device based on the modeled reference chromatogram.

According to a fifth aspect, there is provided a use (method of using) of a modeled reference chromatogram to perform an evaluation, in particular a qualification test, more in particular a system/instrument suitability test, of a chromatography device.

In the context of the present document, the term “evaluation device” may in particular refer to an entity (e.g. a computer, a workstation, a processor, etc.) that is suitable to evaluate the operations conditions of one or more chromatography devices. Preferably, the evaluation device is configured to apply during the evaluation a modeled reference chromatogram. For example, the evaluation device may compare a measured chromatogram with the modeled reference chromatogram. The comparison may yield an information with respect to the quality of the operation conditions. In this manner, it may be evaluated if the operation conditions are as expected or if further adjustments/calibrations have to be done. The evaluation may be seen as a qualification test (in particular a system/instrument test), in particular for a specific configuration. The evaluation may include an analysis of a deviation between measured and (modeled) reference chromatogram.

In the context of the present document, the term “chromatogram modeling device” may in particular refer to an entity (e.g. a computer, a workstation, a processor, etc.) that is suitable to synthesize a chromatogram. In other words, the chromatogram modeling device may be suitable to model a chromatogram. In the present context, the terms “synthesize” and “model” may be used synonymously. According to an example, the chromatogram modeling device is configured to synthesize the modeled reference chromatogram based on a statistical analysis (of measured chromatograms). In another example, a numerical simulation may be applied to synthesize the modeled reference chromatogram. Alternatively or additionally, an artificial intelligence algorithm may be applied to provide the modeled reference chromatogram.

The term “modeled reference chromatogram” may in particular refer to a chromatogram that has not been obtained by an experimental measurement, but is instead artificially produced, in particular by a software.

In the context of the present document, the term “chromatography system” may in particular refer to an arrangement of both entities, the evaluation device and the chromatogram modeling device. In an example, both devices may be implemented into one and the same device, e.g. a chromatography device or a control device of a chromatography device. In another example, both devices may be spatially separated, for example assigned to different entities. In an exemplary embodiment, the evaluation device may be arranged at a customer side, while the chromatogram modeling device may be arranged at a manufacturer side (or vice versa). Still, both devices may be connected, e.g. via a network such as the internet.

In the context of the present document, the term “operation conditions” (or operation parameters) may refer to the conditions under which a chromatography device is configured to operate. For example, the operation conditions may include the hardware such as sampler type, pump type, detector type, syringe type, etc. Further, the operation conditions may include parameters such as flow velocity, pressure, applied solvent, applied samples, etc. Additionally, the operation conditions may also include an age and/or a wearing of the chromatography device. When setting up a chromatography device or a specific program, it is generally necessary to perform adjustment and/or calibration with respect to measured chromatograms. Nevertheless, using an evaluation device as described above, evaluation of the operation condition quality may be done based on a modeled reference chromatogram. An important parameter, when evaluating the operation conditions of a chromatography device, may be the retention time in the chromatogram, which can be different for each configuration (operation condition).

Furthermore, the term “operation conditions” of the chromatography device may particularly denote a set of technical parameters of the chromatography device known beforehand, for instance stored in a data base. Such properties may involve a transport characteristic which may include parameters such as volumes, dimensions, values of physical parameters such as pressure or temperature, and/or physical effects such as a model of friction occurring in a fluidic conduit which friction effects may be modeled, for example, according to the Hagen Poiseuille law. More particularly, the parameterization may consider a size of a chromatography device (for instance a dimension of a fluidic channel), a volume of a fluid conduit (such as a dead volume) of the chromatography device, a pump performance (such as the pump power and/or pump capacity) of the chromatography device, a delay parameter (such as a delay time after switching on a chromatography device) of operating the chromatography device, a friction parameter (for instance characterizing friction between a wall of a fluidic conduit and a fluid flowing through the conduit) of operating the chromatography device, a flush performance (particularly properties related to rinsing or flushing the chromatography device before operating it or between two subsequent operations) of the chromatography device, a flush-out behavior (which may describe the fact that an ideal rectangular pulse/change in mobile phase composition will get distorted in the fluid conduit, e.g. due to mixing, diffusion, etc.) and/or a cooperation of different components of the sample.

The technical (operation) parameters can also be determined with dedicated measurements based on dedicated chromatographic separations or by using sensor data. In order to parametrize a chromatographic device to be evaluated, a set of sensors or chromatographic tests may be provided (e.g. for determining a transfer function as used for emulation (such as ISET), see further below).

In the context of the present document, the term “chromatography device” may in particular refer to an instrument suitable to perform a chromatographic analysis, preferably for analysing a sample, such as for carrying out a chromatographic separation of the sample. Examples of a chromatography device may include a high performance liquid chromatography (HPLC) instrument or a gas chromatography (GC) instrument.

In the context of the present document, the term “customer” may in particular refer to a user of a chromatography device. Hence, a customer may for example be an analysis laboratory and/or the operators of the device within said laboratory. In the specific case that a manufacturer uses the device after manufacturing himself, he may become a customer in this sense. The term “customer side” may denote a domain that is assigned to (and/or controlled by) the customer, for example the mentioned analysis laboratory.

In the context of the present document, the term “manufacturer” may in particular refer to an entity that produces chromatography devices. Further, the term “manufacturer” may also apply to an entity that is responsible for the management of chromatography devices, for example by organizing a data base and/or a network to communicate chromatography-related information. The term “manufacturer side” may hence denote a domain that is assigned to (and/or controlled by) the manufacturer, for example the manufacture facility or a (central) control/communication environment.

According to an exemplary embodiment, the disclosure may be based on the idea that the operation conditions, in particular uncommon operation conditions, of a chromatography device can be evaluated in an efficient and reliable manner, when the reference chromatogram for said operation conditions, which reference chromatogram is taken into account for the evaluation, is synthesized/modeled instead of being (experimentally) measured.

Conventionally, each chromatography instrument evaluation needs a reference chromatogram measured by a qualified chromatography instrument. Therefore, the reliable evaluation of uncommon configuration may be a challenge. Even though there may be examples in the prior art of theoretical chromatograms, these theoretical chromatograms are used only to interpret measured chromatograms and not to evaluate the operation conditions of a chromatography device.

It has now been found by the inventors that a surprisingly efficient and reliable

evaluation of said operation conditions can be performed, when the reference chromatogram is modelled (synthesized) instead of being actually measured. In this manner, the theoretically infinite number of possible uncommon instrument (operation) configurations can be applied and evaluated. Thereby, the present disclosure enables a completely new degree of flexibility, when setting up chromatographic methods, while the reliability of the evaluation may be kept constant.

### Exemplary Embodiments

In the following, further embodiments of the disclosure are described. These apply to the device(s) as well as to the method and the use.

In one embodiment, the evaluation device is configured to compare the modeled reference chromatogram with a measured chromatogram from the chromatography device to be evaluated. Hence, the measured chromatogram and the modeled reference chromatogram (as a standard), both referring to the same (uncommon) operation conditions, may be compared. Differences between the chromatograms, in particular regarding retention times, may hence be compared and evaluated, e.g. for determining a degree of deviation.

In one embodiment, the evaluation device is further configured to: provide an evaluation tolerance, when comparing the measured chromatogram with the modeled reference chromatogram, and evaluate, if the measured chromatogram is within the evaluation tolerance. The evaluation may be seen as a (qualification) test of the operation conditions and may yield as a result a quality criterion, such as pass or fail. The quality criterion may have a certain tolerance, depending on the used application. Thus, by selecting the evaluation tolerance, the evaluation may be adapted to the desired application in a flexible manner.

In one embodiment, evaluation comprises a qualification test. The qualification test may be seen as an evaluation of the chromatography device under test that yields a pass or fail regarding specific qualification properties. In an example, the qualification test may be individually set-up. In another example, the qualification test may be standardized, for example as system and/or an instrument test, in particular an instrument suitability test, IST, or a system suitability test, SST. Such tests may be done under the same chromatographic conditions (e.g. flowrate, mobile phase, stationary phase, temperatures, etc.) and with defined analytes in the sample. In the present context, a system suitability test may be well defined, in particular in regulated environments (e.g. pharma industry). A system suitability test is done by running a known method with a known sample and checking criteria of the gathered chromatogram against limits, e.g. x expected peaks, with expected retention times +/−x etc. SST is e.g. used in the beginning of a sequence of measurements and if it fails the (usually manually check) the whole sequence is aborted. In the present context, an instrument suitability test (or qualification) may be well defined as well, yet less restrictive regarding the qualification than in regulated environments.

In one embodiment, the synthesis of the modeled reference chromatogram comprises a simulation and/or a statistic analysis.

In the context of this document, the term “simulation” may denote any imitation of a real-world process/system over time. A plurality of information/parameter may be provided to set up a numerical simulation of a reference chromatogram. Said simulation may be based on a prediction algorithm and may be further developed, e.g. based on comparison with actually measured chromatograms and/or further modeled reference chromatograms.

In the context of this document, the term “statistical analysis” may denote any collection and/or interpretation of data in order to determine specific observations and/or patterns within the data set. For example, a plurality of chromatograms (e.g. collected in a data base) may be combined and interpreted to thereby deduce/predict a new chromatogram for specific operation conditions.

Parameters taken into account, when synthesizing the modeled reference chromatogram may include i) a configuration of the chromatographic device (e.g. modules, module connection, flow cell, capillaries, filter, mixer, etc.), ii) measured reference chromatogram(s), in particular with comparable configuration(s), more in particular measured by a qualified chromatography device (measured by a customer and/or manufacturer), iii) a state of the chromatography device to be evaluated, e.g. age, wear, etc.).

In one embodiment, the synthesis of the modeled reference chromatogram further comprises a consideration of operational parameters, in particular at least one of an age, a wear, an emulation. As described above, the state of the device may be taken into account, when considering the operation conditions.

In a specific embodiment, the chromatography device to be evaluated is set up to provide an emulation of another chromatography device. In other words, the chromatography device mimics the behavior of another chromatography device, in particular an older device. For example, in the field of chromatography, it may be necessary to perform one and the same analysis during many years. When an accordingly qualified (certified) chromatography device becomes old and is replaced by a new chromatography device, it may be necessary to mimic the old chromatography device to perform exactly the same (certified) analysis again for many years. In this manner, the chromatography device may be evaluated for its operation conditions with respect to mimicking another chromatography device. An example for such an operation may be the “ISET” functionality of Agilent.

For example, patent document WO 2010/025777 A1 describes a method transfer between chromatographic (fluidic) devices considering deviations from ideal behavior. According to an exemplary embodiment, a method or operation mode may be transferred from one technical system to another technical system, more particularly from one chromatography device to another chromatography device, or from a chromatography device in its first configuration (operation conditions) to its second configuration. For instance in a scenario in which a first chromatography device is already certified (for instance by an official authority such as the FDA), a transfer of the certified method to another apparatus to be certified may involve significantly less effort than designing a completely new method or modifying the method manually. Thus, a method which has already turned out to be successful in the past can be transferred with reduced development effort and certification effort to another similar/comparable machine. Hence, an exemplary embodiment provides a system for transferring a method from an old machine generation to a new machine of modern generation, comprising calculating on the basis of a first target operation mode and a configuration of the old machine at first a real operation mode of the old machine.

This first real operation mode may describe how the old machine behaves in practice when being operated according to the first target operation mode in a real physical environment or implementation. Then, a desired operation mode for the new machine can be estimated on the basis of the real operation mode of the old machine and the configuration of the new machine. Particularly for separation devices, this may ensure compatibility of operation of the new machine with the old machine and may allow to design a method for a new machine with reasonable effort. Particularly the latter procedure of deriving a target operation mode for the new machine based on the real operation mode of the old machine and the configuration of the new machine may be executed by performing numeric fitting algorithms, if desired in an iterative manner. Thus, a least squares fit or a best fit according to another criteria may be considered as new operation mode. Such a transfer of a certified method may be particularly advantageous for pharmaceutical industry, where a machine is provided for analyzing medication and/or for performing diagnostics. Thus, such embodiments, especially when validated, may be advantageous for approval purposes, quality control, and reproducibility.

In one embodiment, the synthesis of the modeled reference chromatogram further comprises: apply a data base of (measured) chromatograms (in particular chromatograms measured at least partially by customer) to improve accuracy of the modeled reference chromatogram synthesis. This may be achieved by a) taking at least part of the data base into account, when synthesizing the modeled reference chromatogram and/or b) evaluating the quality of the modeled reference chromatogram based on at least part of the data base.

In the context of the present document, the term “data base” may in particular refer to an organized collection of data, in particular an electronically stored data collection. Said data base may be made accessible by a respective control device as an interface. In an example, the data base may comprise a plurality of experimentally determined chromatograms. In a preferred embodiment, at least part of the experimentally determined chromatograms have been measured on a qualified chromatograph device. In a further example, the data base also comprises modeled reference chromatograms. At least part of the chromatograms may be measured (and/or synthesized) by customers (users of chromatography devices) and are sent (e.g. via a network) to the data base. Additionally or alternatively, chromatograms measured (and/or synthesized) by the chromatography device manufacturer or a chromatography device management entity may be stored in the data base. While in one example, the data base is arranged at the manufacture side, the data base may be arranged in a cloud, or at the customer side in other examples. In a further example, the data base may be (commercially) available and/or accessible.

In embodiment a), the data base may be applied to improve the accuracy of the modeling. For example, a statistical analysis may be complemented by additional chromatograms from the data base, measured for comparable configurations. Additionally or alternatively, a simulation (prediction) algorithm may be improved based on the additional chromatograms from the data base.

In embodiment b), the data base may be applied to evaluate the quality of the modeled reference chromatogram. In particular, the modeled reference chromatogram may be compared with a measured chromatogram with comparable operation conditions. Even though the operation conditions are not equal, the comparison may still enable a judgement of the reliability of the modeled reference chromatogram.

In one embodiment, the synthesis of the modeled reference chromatogram further comprises: apply a measured chromatogram from a qualified chromatography device (in particular of the manufacturer) to improve accuracy of the modeled reference chromatogram generation. This may be achieved by a) taking into account the measured chromatogram from the qualified chromatography device, when synthesizing the modeled reference chromatogram and/or b) evaluating the quality of the modeled reference chromatogram based on the qualified chromatography device.

In the context of the present document, the term “qualified chromatography device” may in particular refer to a chromatography device for which the specific operation conditions (the configuration) has already been successfully evaluated. In other words, the operation conditions have been tested and the quality of the measured chromatogram has been approved and considered as qualified. In a specific example, a qualified chromatography device may be a certified device, e.g. certified by an official authority such as FDA. Even though the chromatogram measured by the qualified chromatography device may be measured for a common configuration and not for an uncommon configuration, it may still be useful to complement or evaluate synthesis of a modeled refence chromatogram.

In one embodiment, the synthesis of the modeled reference chromatogram comprises an artificial intelligence (AI) algorithm, in particular a neural network. The terms “AI”, “machine learning”, and “deep learning” (in the present document, machine learning and deep learning are considered as kinds of AI), may refer to approaches to mimic cognitive functions of a human mind, in particular learning and problem solving. There have been developed a plurality of different mathematic algorithms and computational models to implement AI functionalities. These include for example neural networks, genetic algorithms, support vector machines, and kernel regression. The main purpose of these approaches may be seen in improving a present algorithm by training it using training data, so that a learning effect occurs and the problem solving ability of the algorithm improves over time.

Accordingly, an AI algorithm may be applied to constantly improve the synthesis of modeled reference chromatograms. Simulation as well as statistical analysis may be supported by the AI algorithm. For example, a modeled reference chromatogram may be compared with a measured chromatogram (in particular measured by a qualified chromatography device) and the prediction algorithm may be improved based on the deviation between the chromatograms. Evolution of the AI algorithm may be accompanied by human interaction or may be completely automatic.

In one embodiment, the chromatography system further comprising: the chromatography device to be evaluated, configured to provide the measured chromatogram. Thus, the chromatography device may directly provide the measured chromatogram which is then compared with the modeled reference chromatogram.

In one embodiment, the chromatography device is a fluidic chromatography device, in particular a high performance liquid chromatography, HPLC, device.

In one embodiment, the chromatography device comprising a mobile phase drive and a separation unit, wherein the mobile phase drive is configured for driving a mobile phase through the separation unit, and the separation unit is configured for chromatographically separating compounds of a sample fluid in the mobile phase.

In one embodiment, the analytical device comprises is a liquid chromatography system, wherein the sample fluid is a sample liquid, the mobile phase is comprised of one or more liquid solvents, and the separation unit is a chromatographic column configured for separating compounds of the sample dissolved in the mobile phase.

Embodiments of the present disclosure might be embodied based on most conventionally available HPLC systems, such as the Agilent 1220, 1260 and 1290 Infinity LC Series (provided by the applicant Agilent Technologies).

The separating device preferably comprises a chromatographic column providing the stationary phase. The column might be a glass, metal, ceramic or a composite material tube (e.g. with a diameter from 50 μm to 5 mm and a length of 1 cm to 1 m) or a microfluidic column (as disclosed e.g. in EP 1577012 A1 or the Agilent 1200 Series HPLC-Chip/MS System provided by the applicant Agilent Technologies). The individual components are retained by the stationary phase differently and separate from each other while they are propagating at different speeds through the column with the eluent. At the end of the column they elute at least partly separated from each other. During the entire chromatography process the eluent might be also collected in a series of fractions. The stationary phase or adsorbent in column chromatography usually is a solid material. The most common stationary phase for column chromatography is silica gel, followed by alumina.

The mobile phase (or eluent) can be either a pure solvent or a mixture of different solvents. It can also contain additives, i.e. be a solution of the said additives in a solvent or a mixture of solvents. It can be chosen e.g. to adjust the retention of the compounds of interest and/or the amount of mobile phase to run the chromatography. The mobile phase can also be chosen so that the different compounds can be separated effectively. The mobile phase might comprise an organic solvent like e.g. methanol or acetonitrile, often diluted with water. For gradient operation water and organic solvent is delivered in separate containers, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth, bio reactor, digestion, or other type of sample preparation.

The fluid is preferably a liquid but may also be or comprise a gas and/or a supercritical fluid (as e.g. used in supercritical fluid chromatography—SFC—as disclosed e.g. in U.S. Pat. No. 4,982,597 A).

The pressure in the mobile phase might range from 2-200 MPa (20 to 2000 bar), in particular 10-150 MPa (100 to 1500 bar), and more particularly 50-130 MPa (500 to 1300 bar).

The HPLC system might further comprise a detector for detecting separated compounds of the sample fluid, a fractionating unit for outputting separated compounds of the sample fluid, or any combination thereof. Further details of HPLC system are disclosed with respect to the aforementioned Agilent HPLC series, provided by the applicant Agilent Technologies.

In one embodiment, the chromatography system further comprising: the data base (in particular of the chromatography device manufacturer) with the plurality of (measured) chromatograms (in particular at least partially measured by customers). Access to the data base may be provided by a respective control device. In an example, the data base is stored at a service provider or in a cloud and accessible by a customer who wants to evaluate a chromatography device and/or synthesize a modeled reference chromatogram.

In one embodiment, the chromatography system further comprising: a network connection (in particular between a customer side and a manufacturer side, more in particular between chromatographic devices and the control device). Such a network, for example internet, may interconnect a plurality of entities and enable exchange of data and services. Alternatively, one or more entities may not be connected to the network and exchange data/services via other (more secure) channels.

In one embodiment, the chromatography system further comprising: a further chromatography device (in particular of the customer) configured to provide a further measured chromatogram, in particular via the network connection, to the data base. This may provide the advantage that the data base is constantly complemented by different data sources. Thereby, the reliability of chromatography synthesis and evaluation of uncommon operation conditions may be improved.

In one embodiment, the method further comprising: providing a first measured chromatogram measured in a first device configuration, in particular by a first customer, to a data base; providing a second measured chromatogram measured in a second device configuration, in particular by a second customer, to the data base. In one embodiment, the method further comprises using the first measured chromatogram and/or the second measured chromatogram when synthesizing the modeled reference chromatogram and/or when evaluating the modeled reference chromatogram.

In one embodiment, the method further comprising: providing the modeled reference chromatogram and/or a calculation algorithm for synthesizing the modeled reference chromatogram to the chromatography device (customer), in particular via a network. In an example, the chromatography device to be evaluated may be supported by another (remote) entity with the modeled reference chromatogram and may perform the evaluation itself. In another example, the chromatography device to be evaluated may be supported with a prediction algorithm only, to perform the synthesis itself. In the case of a complex synthesis that requires a lot of computer power, it may be preferable to perform the calculation at the manufacturer side. In yet another embodiment, the chromatography device to be evaluated receives the complete evaluation from the other entity.

According to an exemplary embodiment, the disclosure may be described as follows: by sending the (measured) chromatogram and instrument configuration (operation conditions) of each executed evaluation (e.g. IST) via a (preferably anonymized) feedback channel to the manufacturer, the various chromatograms and instrument configurations can be collected, e.g. in a data base. With every new data set for a specific configuration, the prediction algorithm (e.g. equation/neuronal network) and the expected modeled reference chromatogram may be improved. This improves the statistical data for commonly used configurations but also results in data sets for all less used configurations that are not or cannot be set up and evaluated. The resulting prediction (modeled reference chromatogram) is then deployed back to the control units at the customer side, e.g. by using the same channel. The control unit can then use the up-to-date prediction or as fallback the pre-installed one. By implementing a switch, the algorithm could either use a) the provided calculation algorithm to derive the predicted (modeled reference) chromatogram or b) the pre-calculated (modeled reference) chromatogram provided via the back channel. b) would be in particular used if the generation of the chromatogram gets more complex and requires more computing power than available on the control units in the field.

According to an embodiment, the disclosure may be described as follows: a chromatography device/system, e.g. an HPLC, may be a technically important analytic device that has high precision requirements. Accordingly, specific operation conditions have to be evaluated on a continuous basis to guarantee the required high quality measurements. A conventional approach may be to compare a measured chromatogram with a previously measured standard chromatogram for similar operating conditions. Nevertheless, a manufacturer (of chromatographic devices) generally does not have previously measured standard chromatograms available for every possible system configuration. It follows that there may be a need to evaluate uncommon operation conditions of a chromatography device in an efficient and reliable manner.

According to an embodiment of the disclosure, a reference chromatogram is modeled synthetically (at the manufacturer side), so that a reference chromatogram can be provided even for uncommon chromatographic device operating conditions of a customer. For this purpose, the customer can connect himself (e.g. by a communication channel, a back-channel, a network, etc.) to (a data base at) the manufacturer side to get said synthetically modelled reference chromatogram (directly) from the manufacturer.

In order to model the reference chromatogram in an accurate and reliable manner, a data base may be used (at the manufacturer side) to support the modelling process and/or check the modelling result. The data base may hereby comprise a plurality of chromatograms that have been measured by other customers (the data base may also include chromatograms measured by the manufacturer) for different chromatography device operation conditions (and have been provided to the manufacturer, e.g. via the (back-) channel, the network, etc.). By collecting these measured customer chromatograms (at the manufacturer side), costs and efforts may be saved, while the accuracy of the modelling can be improved. In this manner, a customer may be supported by the manufacturer with accurate/reliable reference chromatograms even in case of uncommon device operating conditions.

### BRIEF DESCRIPTION OF DRAWINGS

Other objects and many of the attendant advantages of embodiments of the present disclosure will be readily appreciated and become better understood by reference to the following more detailed description of embodiments in connection with the accompanied drawings. Features that are substantially or functionally equal or similar will be referred to by the same reference signs.

FIG. 1 illustrates a chromatography system according to an exemplary embodiment.

FIG. 2 illustrates a chromatography system according to a further exemplary embodiment.

FIGS. 3 to 6 respectively show exemplary examples of synthesizing a modeled reference chromatogram.

### DETAILED DESCRIPTION

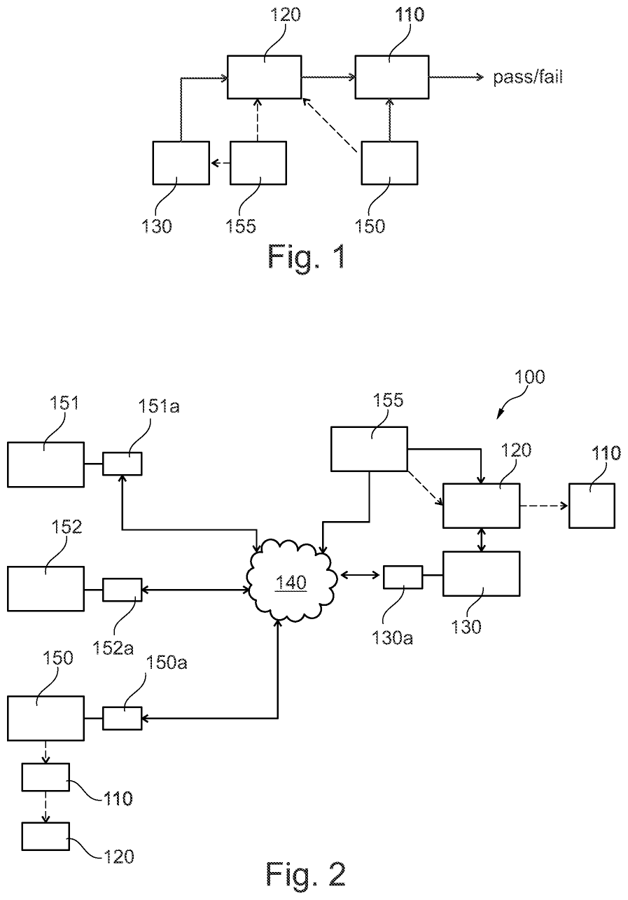

Referring now in greater detail to the drawings, FIG. 1 depicts a chromatography system 100 according to an exemplary embodiment. The chromatography system 100 comprises a chromatogram modeling device 120 configured to synthesize a modeled reference chromatogram corresponding to specific operation conditions of a chromatography device 150, and an evaluation device 110 for evaluating the operation conditions of the chromatography device 150 based on the modeled reference chromatogram.

The chromatogram modeling device 120 is configured to synthesize the modeled reference chromatogram based on a statistical analysis and/or a (numerical) simulation. The modeling (prediction) algorithms can be complemented by an AI algorithm. While in an example, the chromatogram modeling device 120 is configured to function as a stand-alone device, in the example shown, the chromatogram modeling device 120 is supported by data (in particular chromatograms) from a data base 130 and a qualified fluidic chromatography device 155. In a preferred example, a plurality of qualified chromatographic devices 155 feed the data base 130 with chromatograms.

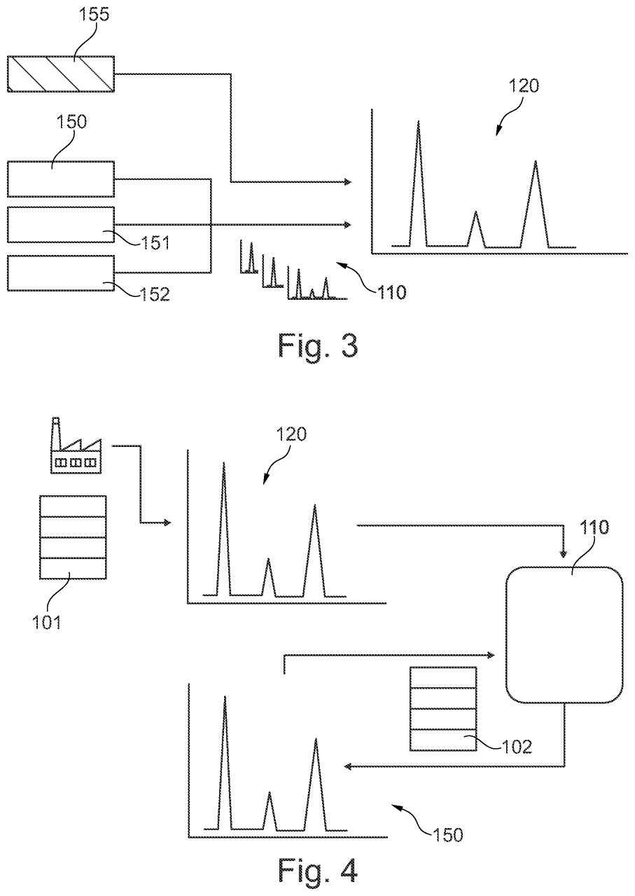

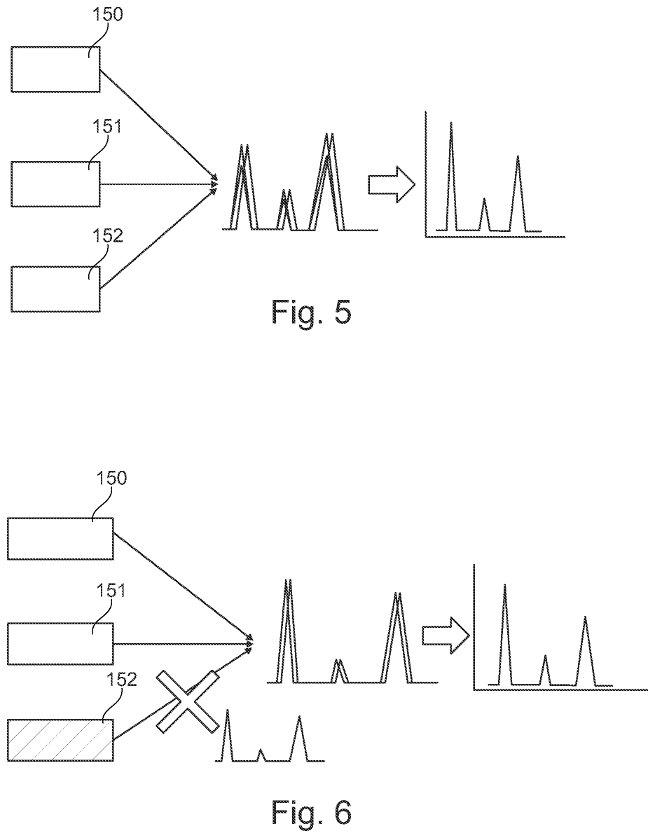

As will be described in detail for FIG. 2 below, access can be provided, via a control device 130a, to a data base 130 that comprises a plurality of stored (measured) chromatograms for specific operation conditions. These stored (experimental) chromatograms can be either taken into account, when synthesizing the modeled reference chromatogram (see FIG. 3), and/or used to evaluate the quality of the modeled reference chromatogram (see FIGS. 5 and 6).

In a similar manner, a measured chromatogram of a qualified chromatography device 155 (in particular from a manufacturer) can be applied, when synthesizing the modeled reference chromatogram, and/or used to evaluate the quality of the modeled reference chromatogram (see FIG. 3).

The evaluation device 110 is coupled in this example with the chromatogram modeling device 120 and both devices 110, 120 are arranged in the same entity. In yet another example (see also FIG. 2), both devices 110, 120 can belong to different (spatially separated) entities. For example, the evaluation device 110 is assigned to the customer side, while the chromatogram modeling device 120 is assigned to the manufacturer side. Further, in the example shown, the evaluation device 110 is coupled with a chromatography device 150, whereby the operation conditions of said chromatography device 150 are to be evaluated.

The evaluation device 110 receives in this example the modeled reference chromatogram from the chromatogram modeling device 120 for the specific operation conditions and the (experimental) chromatogram measured under said operation conditions from the chromatography device 150. Then, the evaluation device 110 will compare the measured and the modeled reference chromatogram and decide, based on the comparison, if the quality of the operation conditions are acceptable (pass) or not (fail). Hereby, it can be considered if the deviation between measured and modeled chromatogram is in an evaluation tolerance. Based on said evaluation, the chromatography device 150 can be classified as ready for use (for the specific operation conditions) or has to be further adjusted/calibrated.

FIG. 2 illustrates a more complex embodiment of the chromatography system 100 that has been described for FIG. 1 above. Depicted with reference sign 150 is a (liquid) chromatography device that is to be evaluated for specific operation conditions. The chromatography device 150 belongs to a customer (user of the device) and is arranged in a laboratory. In an example, the chromatography device 150 can be equipped with or be coupled to a proximate evaluation device 110 and/or chromatogram modeling device 120. In such an embodiment, the chromatography device 150 could perform the synthesis of the modeled reference chromatogram and/or the evaluation of the operation conditions directly at the customer side. For each chromatographic device 150, 151, 152, a specific control device 150a, 151a, 152a is shown schematically to enable connection with a network 140.

In an additional example, the chromatography device 150 is coupled via a network connection 140 to a side of the manufacturer and/or another entity. The network connection 140 can enable access (e.g. via a control device 130a) to a chromatogram data base 130. A plurality of (measured) chromatograms are stored in said data base 130. The data base 130 can be constructed (at least partially) based on measured chromatograms from customers. For example, chromatography device 151 of a first customer and chromatography device 152 from a second customer are coupled via the network connection 140 (and the control device 130a) to the data base 130. Thereby, measured chromatograms for specific operation conditions can be stored and managed in the data base 130, for example on the manufacturer (or other entity) side. In a further example, the data base 130 can be stored in a cloud and thereby be accessible for the described entities.

In this manner, the data base 130 can be accessed and the stored chromatograms can be used to improve the synthesis of the modeled reference chromatogram and/or to evaluate the quality of the modeled reference chromatogram.

The chromatography system 100 further comprises a qualified chromatography device 155 that is already considered as tested (calibrated) and reliable. Therefore, it is known that the measured chromatogram of the qualified chromatography device 155 reliably corresponds to specific operation conditions. In an example, these conditions can be comparable to those of the chromatography device 150 to be evaluated. The qualified chromatography device 155 can be assigned to the manufacturer side or another entity and is preferably coupled to the network connection 140. Thereby, the qualified chromatography device 155 can send its measured chromatogram, like a chromatogram from the data base 130, to the described entities, or even into the data base 130. According to the chromatogram(s) from the data base 130, the chromatogram from the qualified chromatography device 155 can be used to improve the synthesis of the modeled reference chromatogram and/or to evaluate the quality of the modeled reference chromatogram.

It can be seen in the FIG. 2 that the manufacturer side also comprises a chromatogram modeling device 120 and an evaluation device 110. The chromatogram modeling device 120 can be further supported via the data base 130 and/or by the qualified chromatography device 155.

It is thereby schematically illustrated that the described chromatography system 100 can be designed in a very flexible manner that enables a plurality of different configurations and architectures. In a first example, the evaluation device 110 and the chromatogram modeling device 120 are arranged at the customer side and may be supported by the qualified chromatography device 155 and/or the data base 130 via the network connection 140. In a second example, the evaluation device 110 and the chromatogram modeling device 120 are arranged at the manufacturer side and are supported by the qualified chromatography device 155 and/or the data base 130 directly. In a third example, the chromatogram modeling device 120 is arranged at the manufacturer side and provides the modeled chromatogram or an algorithm to produce the modeled chromatogram to the customer side, in particular to an evaluation device 110 at the customer side. In a fourth example, the chromatogram modeling device 120 is arranged at the customer side and provides the modeled chromatogram or an algorithm to produce the modeled chromatogram to the manufacturer side, in particular to an evaluation device 110 at the manufacturer side. These are merely examples schematically shown in FIG. 2. The skilled person can think of many further connections between the described entities.

FIG. 3 shows an exemplary embodiment of synthesizing the modeled reference chromatogram by the chromatogram modeling device 120. It is schematically shown that a plurality of devices, i.e. the qualified chromatography device 155 and three chromatography devices 150, 151, 152 of different customers, respectively provide a measured chromatogram for specific operation conditions. All of these chromatograms can be taken into account, when synthesizing the modeled reference chromatogram 120. Additionally or alternatively, the quality of the modeled reference chromatogram 120 is evaluated based on the qualified chromatography device 155 chromatogram and/or the plurality of chromatograms from the chromatography devices 150, 151, 152.

FIG. 4 shows an exemplary embodiment of evaluating the operation conditions of a chromatography device 150 of a customer. At the manufacturer side, chromatograms for standard operation conditions (shown schematically by reference sign 101) are available. Nevertheless, the operation conditions of the chromatography device 150 of the customer is uncommon (shown schematically by reference sign 102), so that no corresponding experimental chromatogram exists at the manufacturer side.

For this reason, a modeled reference chromatogram is synthesized by a chromatogram modeling device 120 at the manufacturer side (e.g. considering modeling parameters or transfer functions (as used for ISET) for the synthesis of the reference chromatogram, which describe the system behavior of the chromatography device 150) and is then sent (e.g. via a network connection 140) to the customer side, where an evaluation device 110 is installed. Alternatively, chromatograms can be determined experimentally at the manufacturing site as contract work by setting up a chromatographic device that mimics the uncommon operating conditions 102 of the chromatography device 150. The evaluation device 110 is configured to compare the modeled reference chromatogram with a measured chromatogram for the uncommon operation conditions 102. Based on the comparison, the evaluation device 110 can determine, if the operation conditions fulfill a specific quality criterion (and the chromatography device 150 is ready for use) or if the quality criterion is not fulfilled and further calibration is necessary.

FIG. 5 shows an exemplary embodiment of synthesizing the modeled reference chromatogram. The experimental data (measured chromatograms) from several chromatography devices 150, 151, 152 are taken into account, when synthesizing the modeled reference chromatogram, for example either by statistical analysis or simulation.

FIG. 6 shows a further exemplary embodiment of synthesizing the modeled reference chromatogram. When evaluating the incoming experimental data (measured chromatograms), it has been detected that one of said chromatograms 152 is quite different from the others 150, 151. It is therefore concluded that chromatogram 152 is not suitable to be taken into account, when synthesizing the modeled reference chromatogram.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

### REFERENCE SIGNS

100 Chromatography system
101 Common configuration
102 Uncommon configuration
110 Evaluation device
120 Chromatogram modeling device
130 Data base
140 Network
150 Chromatography device
151 Further (first) chromatography device
152 Further (second) chromatography device
155 Qualified fluidic chromatography device
130a, 150a, 151a, 152a respective control devices

1. A chromatography system, comprising:
a chromatogram modeling device for synthesizing a modeled reference chromatogram for specific operation conditions of a chromatography device;
an evaluation device for evaluating operation conditions of the chromatography device based on the modeled reference chromatogram; and
a data base with a plurality of chromatograms that are at least partially measured by customers;
wherein the synthesis of the modeled reference chromatogram further comprises:
applying the data base of chromatograms, measured at least partially by customers, to improve accuracy of the modeled reference chromatogram synthesis by at least one of
taking at least part of the data base into account, when synthesizing the modeled reference chromatogram,
evaluating the quality of the modeled reference chromatogram based on at least part of the data base.

2. The chromatography system according to claim 1, wherein the evaluation device is configured to:
compare the modeled reference chromatogram with a measured chromatogram from the chromatography device to be evaluated.

3. The chromatography system according to claim 2, wherein the evaluation device is further configured to:
provide an evaluation tolerance, when comparing the measured chromatogram with the modeled reference chromatogram, and
evaluate, if the measured chromatogram is within the evaluation tolerance.

4. The chromatography system according to claim 1,
wherein the evaluation comprises at least one of: a qualification test; a system suitability test (SST); an instrument suitability test (IST).

5. The chromatography system according to claim 1,
wherein the synthesis of the modeled reference chromatogram comprises at least one of:
a simulation,
a statistic analysis.

6. The chromatography system according to claim 1,
wherein the synthesis of the modeled reference chromatogram further comprises a consideration of at least one of: operational parameters; an age; a wear; an emulation.

7. The chromatography system according to claim 1, wherein the synthesis of the modeled reference chromatogram further comprises:
applying a measured chromatogram from a qualified chromatography device to improve accuracy of the modeled reference chromatogram synthesis by:
taking into account the measured chromatogram from the qualified chromatography device, when synthesizing the modeled reference chromatogram and/or
evaluating the quality of the modeled reference chromatogram based on the qualified chromatography device.

8. The chromatography system according to claim 1,
wherein the synthesis of the modeled reference chromatogram comprises at least one of: an artificial intelligence algorithm; a neural network.

9. The chromatography system according to claim 1, further comprising:
the chromatography device to be evaluated, configured to provide the measured chromatogram.

10. The chromatography system according to claim 9,
wherein the chromatography device is selected from the group consisting of: a fluidic chromatography device; a high performance liquid chromatography (HPLC) device; and a gas chromatography device (GC).

11. The chromatography system according to claim 1, further comprising:
a connection between a customer side and a manufacturer side.

12. The chromatography system according to claim 11,
wherein the connection is established between at least one chromatographic device and the data base.

13. The chromatography system according to claim 11,
wherein the connection comprises at least one of a network connection, a communication channel.

14. The chromatography system according to claim 1, further comprising:
a further chromatography device configured to provide a further measured chromatogram to the data base.

15. A method, comprising:
synthesizing a modeled reference chromatogram; and
evaluating operation conditions of a chromatography device based on the modeled reference chromatogram;
wherein the synthesis of the modeled reference chromatogram further comprises:
applying a data base of chromatograms, measured at least partially by customers, to improve accuracy of the modeled reference chromatogram synthesis by at least one of
taking at least part of the data base into account, when synthesizing the modeled reference chromatogram,
evaluating the quality of the modeled reference chromatogram based on at least part of the data base.

16. The method according to claim 15, further comprising:
providing a first measured chromatogram measured in a first device configuration to the data base;
providing a second measured chromatogram measured in a second device configuration to the data base; and
using the first measured chromatogram and/or the second measured chromatogram when synthesizing the modeled reference chromatogram and/or when evaluating the modeled reference chromatogram.

17. The method according to claim 16, further comprising:
providing at least one of
the modeled reference chromatogram,
a calculation algorithm for synthesizing the modeled reference chromatogram,
to the chromatography device customer.

18. The method according to claim 17,
wherein providing comprises a communication connection.
